(19) United States
(12) Patent Application Publication
(10) Pub. No.: US 2010/0122664 A1
(43) Pub. Date: May 20, 2010

(54) Pop out bracket

(76) Inventor: Barry E. Weatherbee, JR., Phoenix, AZ (US)

Correspondence Address: Barry E. Weatheree Jr., 3219 E. Camelback Road Building #481, Phoenix, AZ, 85018, US

(21) Appl. No.: 12/313,058

(22) Filed: Nov. 18, 2008

(51) Int. Cl. A01K 15/02; A47B 96/06; E04H 17/14

(52) U.S. Cl. 119/705; 248/309.1; 256/65.07

(57) ABSTRACT

A Pop Out Bracket including an impact release system for use in connection with a stake when mounted to a cross country equestrian fence and other devices. The Pop Out Bracket is a one-piece assembly comprising of plastic materials with holes for mounting with screws or other fixtures and is configured to flex open from the fence upon a sufficient impact or force allowing the stake to come out and fall to the ground. The Pop Out Bracket allows for quick replacement of the stake discontinuing the need to stop a show for course builders to have to replace a stake and or re-screw in a stake. The Pop Out Bracket lowers the danger to the horse and rider by allowing the stake to fall to the ground and not allowing the stake to stay in position and break causing possible injury to the horse or rider.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR COMPUTER PROGRAM LISTING COMPACT DISC APPENDIX

“Not Applicable”

### BACKGROUND OF THE INVENTION

Wood Stakes screwed to a jump is known. For example, most course designers and builders, use standard screws to screw through a wood 2×2 stake attaching it to a jump. Such mounted stakes create a danger to the horse and rider either not allowing the stake to fall to the ground or allowing the stake to break and injure horse or rider. Three holes on the base of the Pop Out Bracket allow the Pop Out Bracket to be secured to a jump with the use of screws or other securing means. Stakes mounted to jumps, especially for use in connection with equestrian jumping or other similar sports, presents certain safety issues that, prior to the invention described herein, have not been adequately addressed.

Specifically, a horse or person falling or hitting a stake presents a feature that, during a fall where the rider or horse contacts the stake for example, can catch the stake or otherwise be problematic during a fall. For example, the current method of attaching a stake can cause the stake upon impact to break and stab the horse or rider or not move causing a serious fall and in both cases causing serious injury or even death. Accordingly, a need in the art exists for methods and apparatuses that provide an attachment for a stake mounted to a jump that addresses the safety concerns discussed above. The present invention substantially fulfills this need.

The present invention relates to mounting brackets and, more particularly, to a mounting bracket featuring a flex open impact release mechanism. Embodiments of the present invention are especially adapted for use in connection with Equestrian Stakes typically used by horsemen, cross country jumping, and other sports enthusiasts.

### BRIEF SUMMARY OF THE INVENTION

A Pop Out Bracket including an impact release system for use in connection with a stake when mounted to a cross country equestrian fence and other devices. In one embodiment, the Pop Out Bracket is a one-piece assembly comprising of plastic materials with holes for mounting with screws or other fixtures and is configured to flex open from the fence upon a sufficient impact or force allowing the stake to come out and fall to the ground. In one embodiment, the Pop Out Bracket allows for quick replacement of the stake discontinuing the need to stop a show for course builders to have to replace a stake and or re-screw in a stake. In one embodiment, the impact release mechanism is configured to allow the Pop Out Bracket to open away from the fence without affecting the subsequent utility of the Pop Out Bracket. After the Pop Out Bracket opens from the fence, the Pop Out Bracket returns to its stable position to be reused again. The stake is then replaced back into position by a person and is ready for use again. Other embodiments of the present invention features failure points wherein the failure point is integrally formed to predefined thicknesses that allow the Pop Out Bracket to break and fall away from the fence upon sufficient impact that is not correctly used and or upon receiving sufficient impact from the incorrect direction allowing the stake to come out and fall to the ground.

### BRIEF DESCRIPTION OF THE SEVERAL VIEWS OF THE DRAWING

FIG. 1A is a side view of the Pop Out Bracket according to an embodiment of the present invention.

FIG. 1B is a top view of the Pop Out Bracket according to an embodiment of the present invention.

FIG. 2 is a perspective illustrating application of the Pop Out Bracket, according to an embodiment of the present invention, to an equestrian fence using screws holding a stake with a flag attached to an equestrian jump.

### DETAILED DESCRIPTION OF THE INVENTION

The Pop Out Bracket is a mounting bracket including an impact release system for use in connection with a stake when mounted to a cross country equestrian fence and other devices. In one embodiment, the Pop Out Bracket is a one-piece assembly comprising of plastic materials with holes for mounting configured to flex open from the fence upon a sufficient impact or force allowing the stake to come out and fall to the ground. In one embodiment, the Pop Out Bracket allows for quick replacement of the stake discontinuing the need to stop a show for course builders to have to replace a stake and or re-screw in a stake. In one embodiment, the impact release mechanism is configured to allow the Pop Out Bracket to open away from the fence without affecting the subsequent utility of the Pop Out Bracket. After the Pop Out Bracket opens from the fence, the Pop Out Bracket returns to its stable position to be reused again. The stake is then placed back into position by a person and is ready for use again. Other embodiments of the present invention features a failure point. Wherein, the failure point is integrally formed to a predefined thickness that allows the Pop Out Bracket to break away from the fence upon sufficient impact that is not correctly used and or upon receiving sufficient impact from the incorrect direction allowing the stake to come out and fall to the ground.

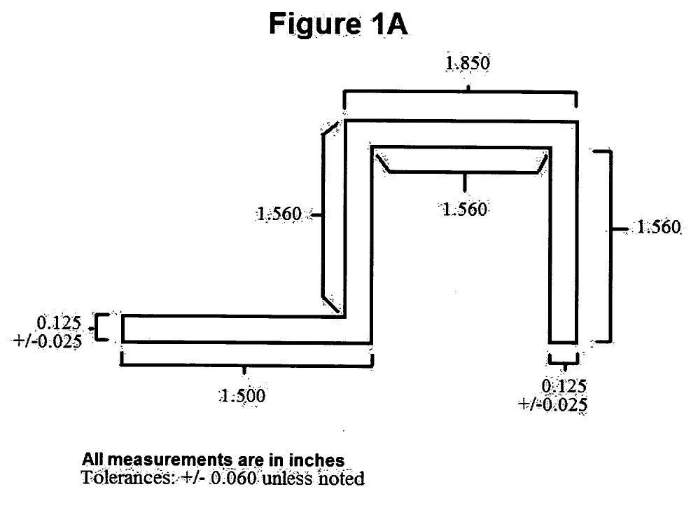

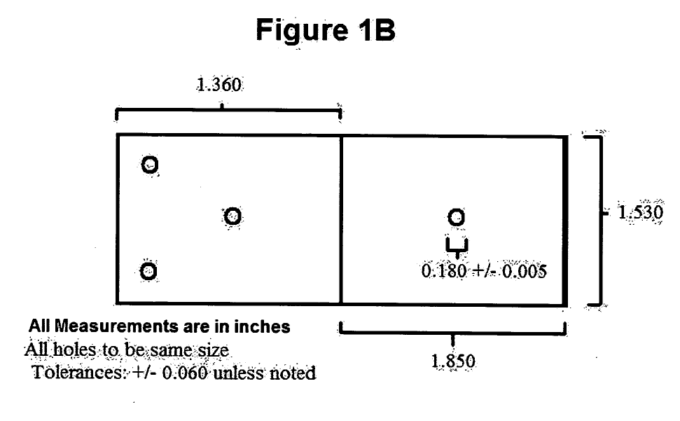

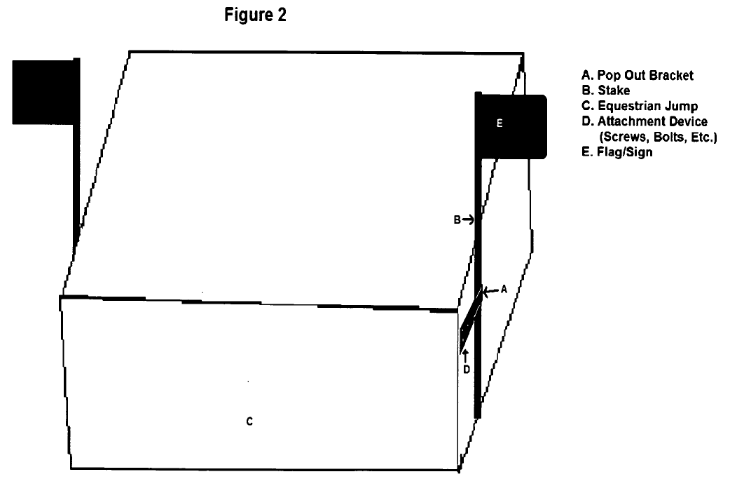

FIG. 1A and 1B illustrate a Pop Out Bracket configured according to an embodiment of the present invention. As FIG. 1A and 1B provides, Pop Out Bracket, in one embodiment, with the measurements. As FIG. 2 illustrates, Pop Out Bracket (A) is attached to an equestrian jump(C) using screws(D) allowing the bracket to have a side come away from the jump along the side of the stake(B), a side go over the stake(B) and a side to do back toward the jump(C), holding the stake(B) to the jump(C). Of course, as one skilled in the art will recognize any suitable means for attaching the Pop Out Bracket to an equestrian jump can be used(screws, bolts, etc.). In addition, the Pop Out Bracket can be used without being attached to a jump. For example, the Pop Out Bracket can be used with a ditch, log, bank, or any other suitable obstacle.

In one embodiment, the Pop Out Bracket is a plastic part fabricated by an injection molding process. For example, the Pop Out Bracket can be made of polyvinylchloride, nylon, polycarbonate, polyethylene, or any other suitable material. In one embodiment, the Pop Out Bracket can be made of steel, aluminum or other metal. In one embodiment, the Pop Out Bracket can be fabricated by Extrusion, Casting, or any other suitable process.

In addition, as FIG. 2 the Pop Out Bracket can be mounted in different locations as well as on separate items, such as on the front of the equestrian jump.

FIG. 2 illustrates one application of the Pop Out Bracket configured according to the present invention. As FIG. 2 illustrates, the Pop Out Bracket can be used to allow the stake to essentially pop out of the Pop Out Bracket during a strong-impact. Specifically, as discussed above, the Pop Out Bracket attaches to a jump using any suitable means, such as screws connected to the jump.

FIG. 1A and 1B lists the dimensions of the Pop Out Bracket, which are configured in such a manner that the stake will releases from the Pop Out Bracket upon application of a sufficient force. Specifically, the plastic or other deformation of Pop Out Bracket upon application of sufficient force (caused, for example, by a rider or horse impacting the stake while jumping the fence) allows the Pop Out Bracket to open up releasing the stake.

As one skilled in the art will recognize, the present invention can be implemented in a wide array of different embodiments. For example, the Pop Out Bracket need not be mounted to the side of the jump. For example, the Pop Out Bracket could be mounted to the front of the jump. Also, the Pop Out Bracket need not necessarily be square. For example it can be rounded allowing for the same effect. Also, the Pop Out Bracket need not necessarily to this size it can be larger or smaller in size. For example, if a larger stake is used a large Pop Out Bracket would be used. Also, the bracket can be mounted to many different types of jumps or apparatuses. For example, it can be used on a Cross-Country fence or a Steeplechase fence.

Still further, the Pop Out Bracket has failure points where upon application of a sufficient force at the failure points the Pop Out Bracket will break. This will allow the stake to release from the jump keeping horse or rider from being hurt by the impact of the stake. This also eliminates dangers with improper use of the Pop Out Bracket.

In addition, other embodiments of the present invention feature a two-piece design wherein the Pop Out Bracket has two pieces together wherein to Z shaped forms are put together creating the stake to pop out through the center instead of the side. According to this embodiment, the Pop Out Bracket at the opposite side of the attached area includes a release point upon application of a sufficient force. Another embodiment of the present invention is the hole placement for mounting wherein numerous other locations can be used for mounting creating a similar effect as the current design.

Lastly, although the present invention has been described with reference to specific embodiments, various other embodiments are possible without departing from the scope of the present invention. Other embodiments of the present invention will be apparent to one of ordinary skill in the art. It is, therefore, intended that the claims set forth below not be limited to the embodiments described above.

1. A Pop Out Bracket, comprising of a one piece assembly with holes configured for attachment to a cross country equestrian fence/jump and other devices, this bracket attached to cross country equestrian fence/jump and other devices is configured to hold a “2×2 wood” (actually measures 1.500 inches by 1.500 inches square)(or plastic) stake until application of sufficient force; the Pop Out Bracket will allow the stake to fall/pop out, and wherein the bracket comprises of a question mark-shaped arm, wherein the question mark-shaped arm abuts against a surface of the jump and forms around a stake.

2. The Pop Out Bracket of claim 1 wherein the abutting part includes three holes to use screw or other fixtures to attach to the cross country equestrian fence/jump or other such item.

3. The Pop Out Bracket of claim 1 can be attached via the holes on the abutting side on the cross country fence/jump facing either left or right and can be used on all sides of the cross country equestrian fence/jump or other attachments.

4. The Pop Out Bracket of claim 1 when mounted is configured to flex open and allow the stake to come out and fall to the ground or provide flexibility of the stake to move slightly.

5. The center slot is the area designed for the stake to fit into and is configured to allow the stake to come out of the Pop Out Bracket of claim 1 upon sufficient impact or force.

6. The Pop Out Bracket of claim 1 is easy to use compared to current methods. It is easy to attach to the cross country equestrian fence with three screws and allows for reuse.

7. The Pop Out Bracket of claim 1 is easy for the course designer, builder or assistant to use as the slot in the Pop Out Bracket is designed for the stake to slide in easily.

8. The Pop Out Bracket of claim 1 is designed to allow at ease for the jump judge or the like to replace the stake when the stake is released from the Pop Out Bracket of claim 1 after sufficient impact or when needs arise.

9. A person can pick up the stake and slide it back into the Pop Out Bracket of claim 1 with out having to have a delay of the event.

10. The Pop Out Bracket of claim 1 improves safety for the horse and rider where the pop out bracket is configured to flex open and allow the stake to pop out upon sufficient impact or force instead of the horse or rider hitting the stake and being injured or killed.

11. The Pop Out Bracket of claim 1 comes in white, black, brown colors and any custom color.

12. The Pop Out Bracket of claim 1 is made of a custom formulated plastic material that is designed for long wear and outdoor use.

13. The Pop Out Bracket of claim 1 wherein between the abutting area and the area of holding the stake attach at, at least one stress point adapted to break away, thereby releasing the areas from the each other, upon improper installation and upon application of sufficient force.

14. The Pop Out Bracket of claim 1 can be used on any type of fence or structure.

15. The Pop Out Bracket of claim 1 shortens the amount of time for setup and tear down of courses.

16. The Pop Out Bracket of claim 1 has high ultraviolet ray repellents allowing for year round use.

17. The Pop Out Bracket of claim 1 can be left on the fence and does not need removal for jump moving or storage.

18. The Pop Out Bracket of claim 1 allows for the installation by any individual capable of installing screws or the like.

19. The Pop Out Bracket of claim 1 can be used as a fixed bracket not allowing the stake to fall upon significant impact.
